(19) United States
(12) Patent Application Publication
(10) Pub. No.: US 2005/0088412 A1
(43) Pub. Date: Apr. 28, 2005

(54) Mouse-type input devices and related systems

(76) Inventors: Robin Walton, Culver City, CA (US); Orhan E. Beckman, Camas, WA (US); Jennifer Farrell, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/695,213

(22) Filed: Oct. 28, 2003

(51) Int. Cl. G09G 5/08

(52) U.S. Cl. 345/163

(57) ABSTRACT

Input devices are provided. An exemplary input device for a computer comprises a housing, a position-determining system and a trackball. The position-determining system is mounted to the housing, and is operative to determine movement of the housing and to provide a first output corresponding to the movement of the housing. The trackball is mounted to the housing and is operative to rotate and to provide a second output corresponding to rotation of the trackball. Computer systems and other input devices also are provided.

### DESCRIPTION OF THE RELATED ART

Various types of devices are used for providing inputs to computers. By way of example, keyboards and mouse-type input devices conventionally are used. A typical mouse-type input device includes a mechanism for sensing movement of the mouse across a surface, as well as multiple actuators. Specifically, one of the actuators typically is associated with left-click functionality and another of the actuators typically is associated with right-click functionality. Thus, based upon the sensed movement of the mouse-type input device and the state of the various actuators, a user can provide various combinations of inputs to a computer system. Unfortunately, a conventional mouse-type input device is limited in its ability to provide inputs corresponding to complex movements.

### SUMMARY

Input devices and related systems are provided. In this regard, an embodiment of an input device for a computer comprises a housing, a position-determining system and a trackball. The position-determining system is mounted to the housing, and is operative to determine movement of the housing and to provide a first output corresponding to the movement of the housing. The trackball is mounted to the housing and is operative to rotate and to provide a second output corresponding to rotation of the trackball.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a schematic diagram depicting an embodiment of a mouse-type input device.

FIG. 2 is a perspective view of another embodiment of a mouse-type input device.

FIG. 3 is a schematic view depicting another embodiment of a mouse-type input device.

FIG. 4 is a flowchart depicting functionality of the mouse-type input device of FIG. 3.

FIG. 5 is a schematic diagram depicting a computer or processor-based device with which a mouse-type input device can communicate, and which can implement an embodiment of an input system for receiving input from a mouse-type input device.

FIG. 6 is a flowchart depicting functionality of an embodiment of an input system.

FIG. 7 is a schematic diagram depicting a representative image displayed on a display device and an associated mouse-type input device.

FIG. 8 is a schematic diagram of the display device and mouse-type input device of FIG. 7, with the displayed image being modified in response to outputs provided by the mouse-type input device.

FIG. 9 is a schematic diagram depicting a representative image displayed on a display device and an associated mouse-type input device.

FIG. 10 is a schematic diagram of the display device and mouse-type input device of FIG. 9, with the displayed image being modified in response to outputs provided by the mouse-type input device.

### DETAILED DESCRIPTION

As will be described in detail here, mouse-type input devices and related systems are provided. In particular, embodiments of the mouse-type input device are able to provide at least two outputs, a first of which corresponds to movement of mouse-type input device and the second of which corresponds to a two-dimensional input of a user. That is, the second output can comprise information corresponding to a longitudinal component and/or a transverse component.

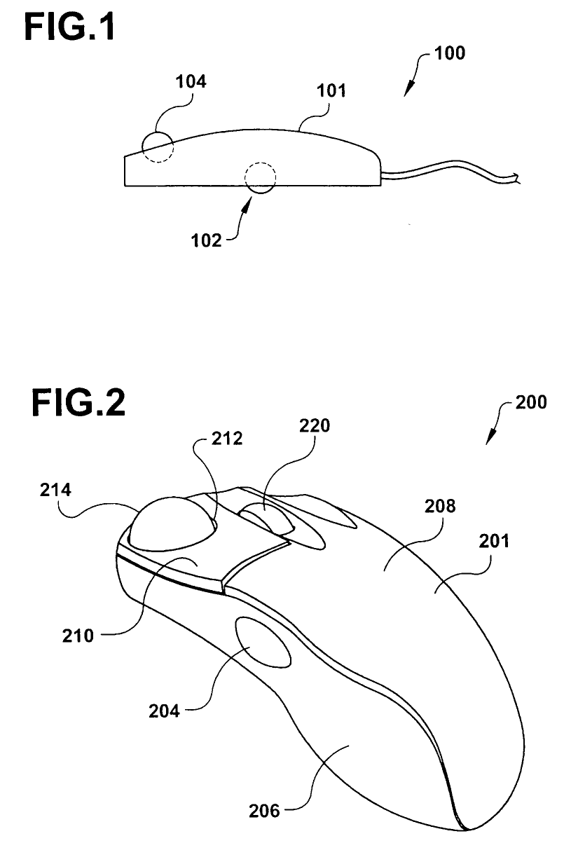

As shown in FIG. 1, an embodiment of a mouse-type input device 100 includes a housing 101. A position-determining system 102 is mounted to the housing. The position-determining system 102 determines movement of the housing, such as with respect to a surface upon which the housing is placed. In response to movement of the housing, the position-determining system provides a first output corresponding to the sensed movement of the housing.

The mouse-type input device 100 also includes a trackball 104. Trackball 104 is rotatable and provides a second output corresponding to a sensed rotation of the trackball. Thus, by rotating the trackball, a user is able to provide a two-dimensional input, i.e., a longitudinal component and/or a transverse component, to a computer system to which the mouse-type input device communicates.

Another embodiment of a mouse-type input device is depicted in the perspective view of FIG. 2. As shown in FIG. 2, mouse-type input device 200 includes a housing 201 that incorporates a trackball, as well as various actuators. Specifically, device 200 includes a left-click actuator 204 that is located on a sidewall 206 of the housing. Thus, when a user grasps the housing so that the top surface 208 of the housing is substantially centered in the palm of the user's hand, the left-click actuator 204 is substantially aligned with the thumb of the user. Note that the mouse-type input device of FIG. 2 is provided in a right-handed configuration. In other embodiments, devices of a left-handed configuration can be provided.

Device 200 also includes a right-click actuator 210. In this embodiment, the right-click actuator 210 defines an aperture 212 through which a portion of a trackball 214 protrudes. In other embodiments, however, the trackball does not protrude through an aperture defined by the right-click actuator, e.g., the trackball can be located adjacent to the right-click actuator. The trackball 214 and right-click actuator 210 are located to align with the index finger of the user when the device is grasped. Thus, in the right-handed configuration embodiment of FIG. 2, the right-click actuator 210 is located on the left side of the housing.

Device 200 also includes a scroll wheel 220 that is located to align with the middle finger of the user. That is, the scroll wheel is generally aligned with the centerline of the housing. Thus, the left-click actuator 204 typically is actuated by the thumb, the trackball 214 and right-click actuator 210 typically are actuated by the index finger, and the scroll wheel 220 typically is actuated by the middle finger of the user.

It should be noted that various types of position-determining systems can be used. For instance, a trackball-type position-determining system was depicted in the embodiment of FIG. 1. In other embodiments, such as in the embodiment of FIG. 2, a position-determining system that utilizes optical-sensing techniques can be used.

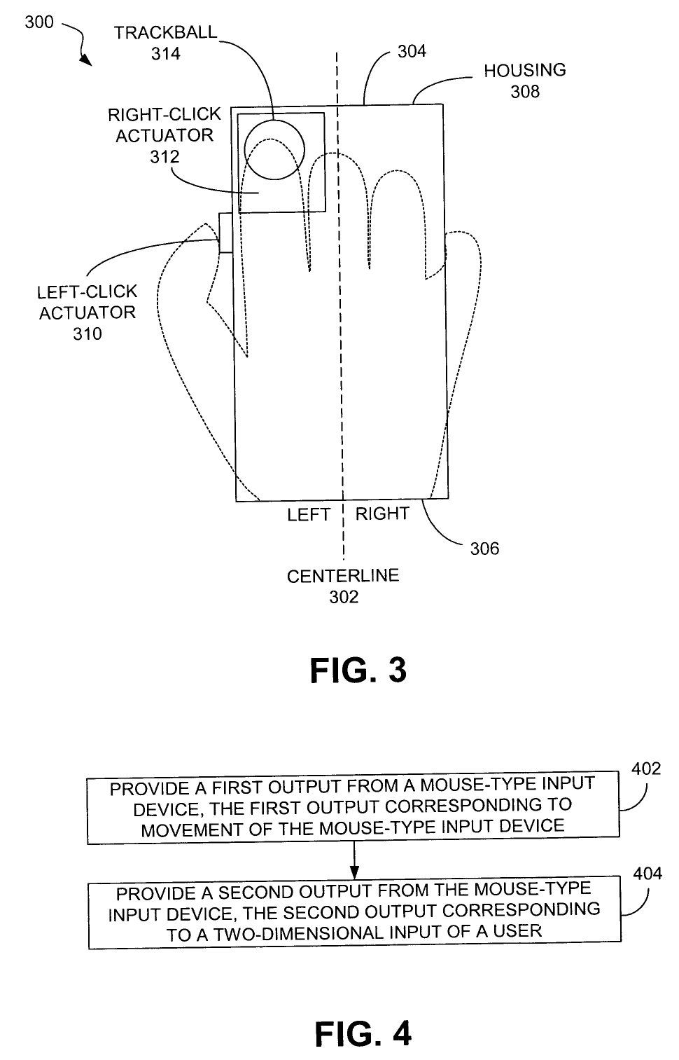

Another embodiment of a mouse-type input device is depicted schematically in FIG. 3. As shown in FIG. 3, mouse-type input device 300 defines a centerline 302 that extends generally longitudinally from the front end 304 to the back end 306 of housing 308. A left-click actuator 310, a right-click actuator 312 and trackball 314 are located substantially to the left of centerline 302. Also note that the right-click actuator 312 is positioned closer to the front end 304 than is the left-click actuator 310.

In the configuration shown in FIG. 3, when the mouse-type input device 300 is grasped by the hand of a user, the thumb of the user typically aligns with the left-click actuator 310 and the index finger of the user typically aligns with the right-click actuator 312 and trackball 314 of the device.

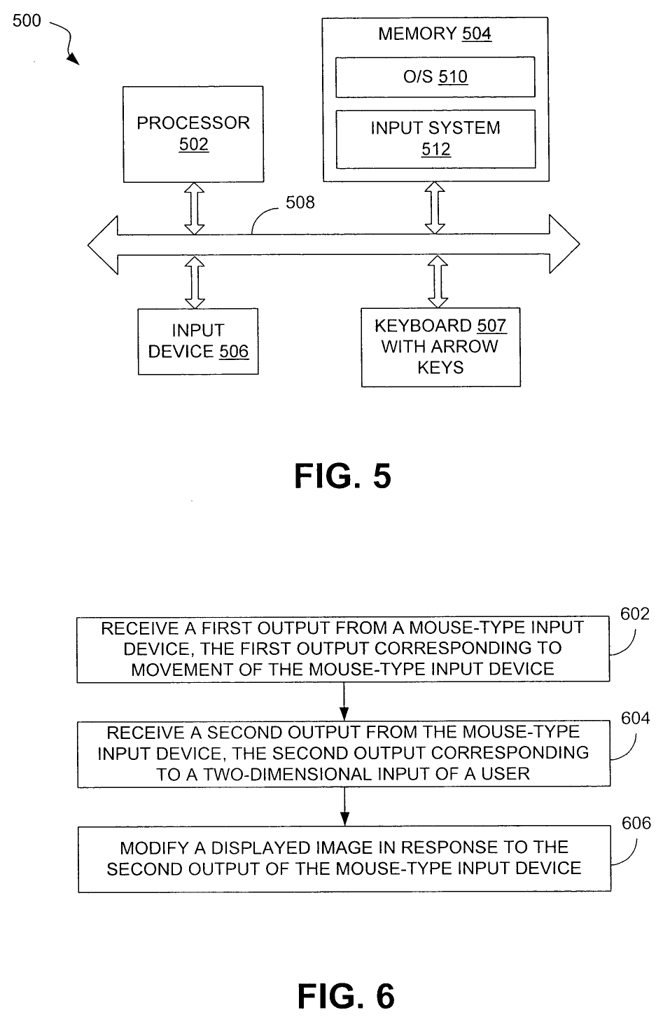

Reference will now be made to the flowchart of FIG. 4 which depicts the functionality of an embodiment of a mouse-type input device. As shown in FIG. 4, the functionality (or method) may be construed as beginning at block 402, where a first output is provided from a mouse-type input device. In particular, the first output corresponds to movement of the mouse-type input device. In block 404, a second output is provided from the mouse-type input device. Specifically, the second output corresponds to a two-dimensional input of a user. By way of example, the second output can be provided in response to the user actuating a trackball that is mounted to a housing of the mouse-type input device. Thus, in such an embodiment, the second output comprises at least one of a longitudinal component and a transverse component. Embodiments of a mouse-type input device typically are used with a computer or processor-based system. An embodiment of such a system is depicted schematically in FIG. 5.

Generally, in terms of hardware architecture, computer 500 includes a processor 502, memory 504, and one or more input and/or output (P/O) devices, such as a mouse-type input device 506 and a keyboard 507. Note that includes arrow keys, e.g., an up-arrow key, a down-arrow key, a left-arrow-key and a right-arrow key. The I/O devices are communicatively coupled via a local interface 508.

The software in memory 504 can include one or more separate programs, each of which comprises an ordered listing of executable instructions for implementing logical functions. In the example of FIG. 5, the software in the memory 504 includes an operating system (O/S) 510 and an embodiment of an input system 512.

When input system 512 is implemented in software, it should be noted that the input system can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. Input system 512 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Functionality of the embodiment of the input system 512 of FIG. 5 is presented in the flowchart of FIG. 6. It should be noted that, in some alternative implementations, the functions noted in the various blocks of this and/or other flowcharts depicted in the accompanying disclosure may occur out of the order depicted. For example, two blocks shown in succession in FIG. 6 may be performed concurrently or, in some embodiments, in reverse order.

As shown in FIG. 6, the functionality (or method) may be construed as beginning at block 602, where a first output is received from a mouse-type input device. Specifically, the first output corresponds to movement of the mouse-type input device. In block 604, a second output is received from the mouse-type input device, with the second output corresponding to a two-dimensional input of the user. In block 606, a displayed image is modified in response to the second output of the mouse-type input device.

In some embodiments, the two-dimensional input provided as the second output of a trackball is redundant to that typically provided by the arrow keys of the keyboard. For instance, an input corresponding to rotating the trackball backward typically corresponds to an output provided by actuating a down-arrow key, an input corresponding to rotating the trackball forward typically corresponds to an output provided by actuating an up-arrow key, an input corresponding to rotating the trackball to the right typically corresponds to an output provided by actuating a right-arrow key, and an input corresponding to rotating the trackball to the left typically corresponds to an output provided by actuating a left-arrow key. In other embodiments, the functionality associated with such arrow keys is remapped to the trackball such that only the trackball is able to provide the previously described functionality. Functionality for remapping the arrow keys to the trackball can be accomplished, in some embodiments, by an input system, such as input system 512 of FIG. 5.

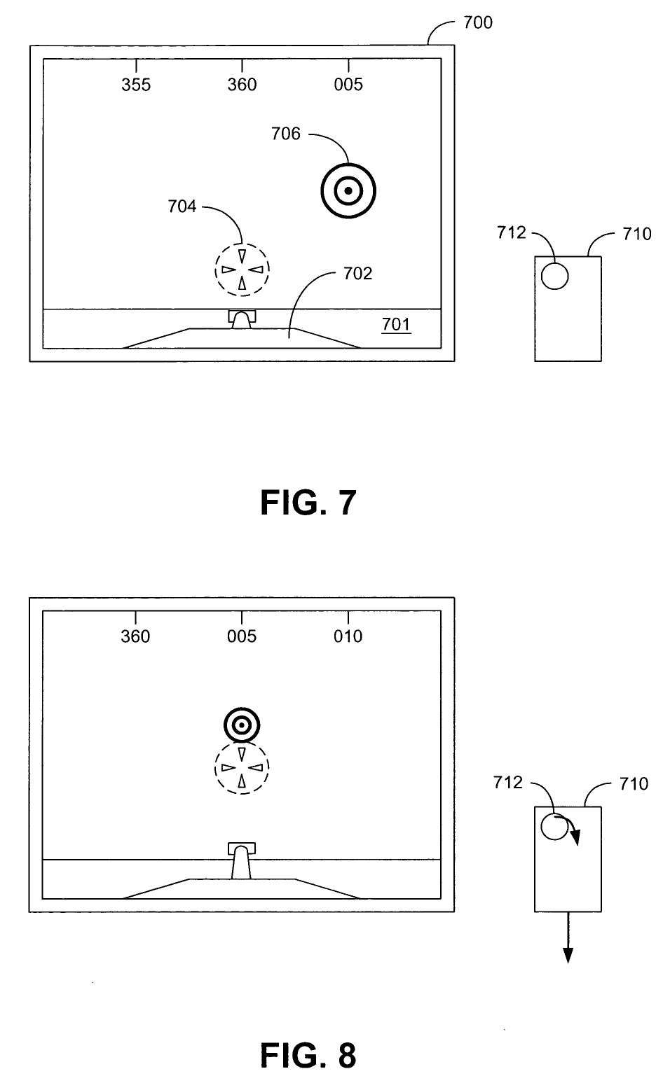

Reference will now be made to several sequences of images that depict exemplary manners in which a displayed image can be modified in response to input provided by embodiments of a mouse-type input device. Referring now to FIGS. 7 and 8, use of an embodiment of a mouse-type input device in a gaming implementation will now be described.

As shown in FIG. 7, a computer display device 700 is used to display an image to a user. Specifically, the image 701 is that provided by a representative first-person shooter game, in which the user virtually occupies a position associated with a weapon. In this case, the user is virtually associated with the turret 702 of a tank, with the sight 704 being the projected aim point of the turret. In order to determine the relative orientation of the tank, arbitrary compass headings are depicted at a top of the display. In this case, the turret is currently facing due north, i.e., 360°. An intended target 706 also is displayed. In particular, the target 706 is present at relatively close range at a position of 005°.

A mouse-type input device 710 that communicates with a computer system that includes the display device 700 is depicted. Note that the mouse-type input device 710 is depicted in a static state in FIG. 7, and includes a trackball 712.

Referring now to FIG. 8, the mouse-type input device has been moved backward and the trackball 712 has been rotated to the right and backward. In response to the output corresponding to movement of the housing of the mouse-type input device, i.e., the backward movement, and the output corresponding to the sensed movement of the trackball, the display image has been modified in several respects. First, the tank has moved backward with respect to the target. Thus, the target 706 appears to be more distant from the tank. Additionally, the aim point or sight 704 of the weapon has been elevated in response to the backward motion of the trackball 712. The turret also has been rotated to 005° to align with the target 706 in response to the rightward movement of the trackball. Thus, the mouse-type input device 710 provides a two-dimensional input for moving the tank, as well as an independent two-dimensional input for moving the turret.

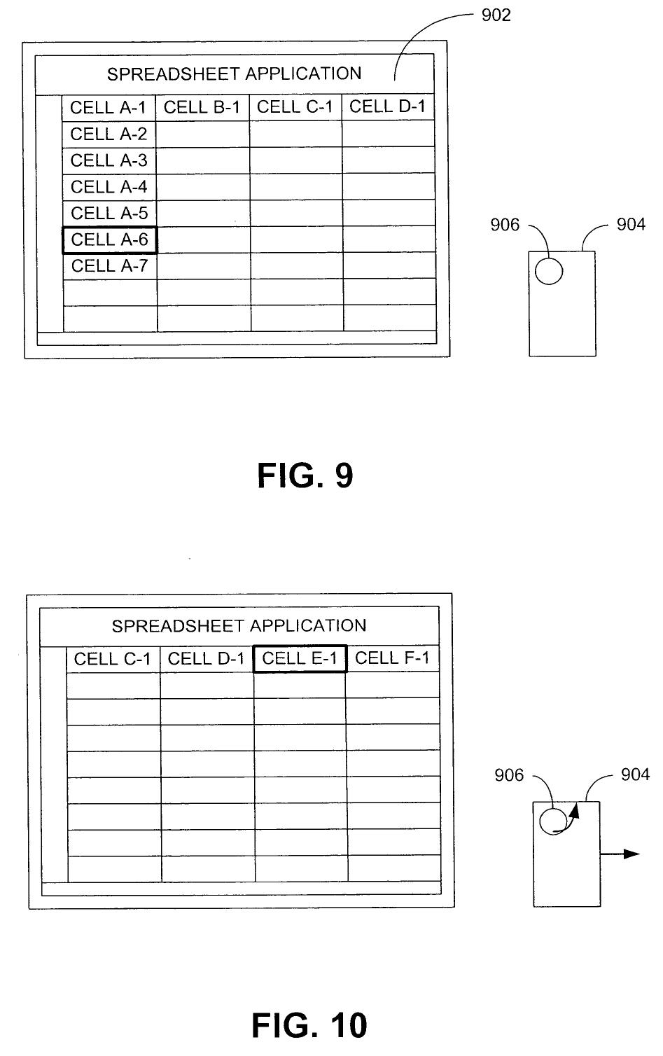

FIGS. 9 and 10 depict operation of an embodiment of a mouse-type input device when used with a spreadsheet application. As shown in FIG. 9, the spreadsheet application 902 includes various cells that are presented in row-and-column format. Note that the mouse-type input device 904 is depicted in a static state in FIG. 9, and includes a trackball 906.

In FIG. 10, the housing of the mouse-type input device 904 has been moved to the right and the trackball 906 has been moved to the right and forward. In response to the corresponding outputs provided by the mouse-type input device, the displayed image has been modified. In particular, in response to the rightward movement of the housing, the window of the spreadsheet has been moved to the right so that cell columns C-F are displayed. In response to the rightward and forward movement of the trackball 906, the highlighted cell has shifted to the right and up, i.e., from cell A-6 to cell E-1.

It should be emphasized that many variations and modifications may be made to the above-described embodiments. By way of example, although only described herein as being used with a first-person shooter implementation and a spreadsheet implementation, embodiments of mouse-type input devices can be used with various other applications. For instance, such a device can be used with applications that require the use of one or more two-dimensional inputs. Additionally, or alternatively, embodiments of such devices could be used when conventional inputs are required, i.e., such devices could be substituted for conventional input devices even though all of their functionality may not be used. All such modifications and variations are intended to be included herein within the scope of this disclosure and protected by the following claims.

1. An input device for a computer comprising:
a housing;
a position-determining system mounted to the housing, the position-determining system being operative to determine movement of the housing and to provide a first output corresponding to the movement of the housing; and
a trackball mounted to the housing, the trackball being operative to rotate and to provide a second output corresponding to rotation of the trackball.

2. The input device of claim 1, wherein:
the housing has a bottom surface; and
the position-determining system is operative to detect movement of a surface upon which the housing is placed relative to the bottom surface of the housing.

3. The input device of claim 2, wherein:
the trackball is a first trackball; and
the position-determining system comprises a second trackball, a portion of which protrudes from the bottom surface of the housing such that the second trackball contacts the surface upon which the housing is placed.

4. The input device of claim 2, wherein:
the housing has a top surface; and
the trackball protrudes from the top surface of the housing.

5. The input device of claim 4, wherein:
the housing is sized and shaped to be grasped by a hand of a user; and
the input device additionally comprises a left-click actuator mounted to the housing such that, when the housing is grasped by the user with the top surface of the housing substantially centered in the palm of the hand, the index finger of the user is aligned with the trackball and the thumb of the user is aligned with the left-click actuator.

6. The input device of claim 4, wherein:
the housing is sized and shaped to be grasped by a hand of a user; and
the input device additionally comprises a right-click actuator mounted to the housing adjacent to the trackball such that, when the housing is grasped by the user with the top surface of the housing substantially centered in the palm of the hand, the index finger of the user is aligned with the trackball and the right-click actuator.

7. The input device of claim 6, wherein the right-click actuator at least partially surrounds the trackball.

8. The input device of claim 6, wherein:
the right-click actuator has an aperture; and
a portion of the trackball protrudes from the housing and through the aperture.

9. The input device of claim 6, wherein:
the housing has a centerline; and
at least a substantial portion of the right-click actuator is located left of the centerline.

10. The input device of claim 6, further comprising:
a scroll wheel mounted to the housing such that, when the housing is grasped by the user with the top surface of the housing substantially centered in the palm of the hand, the middle finger of the user is aligned with the scroll wheel.

11. The input device of claim 10, wherein at least a substantial portion of the right-click actuator is located left of the scroll wheel.

12. The input device of claim 1, wherein the housing is configured and the trackball is arranged to be operated by a right hand of a user.

13. A computer system comprising:
a processor operative to execute instructions;
memory operative to store the executable instructions; and
an input device operative to provide a user interface with the processor, the input device comprising:
a housing;
a position-determining system mounted to the housing, the position-determining system being operative to determine movement of the housing and to provide a first output corresponding to the movement of the housing; and
a trackball mounted to the housing, the trackball being operative to rotate and to provide a second output corresponding to rotation of the trackball.

14. The computer system of claim 13, wherein:
the computer system additionally comprises a keyboard having arrow keys, the arrow keys comprising an up-arrow key, a down-arrow key, a left-arrow key and a right-arrow key; and
the second output of the trackball corresponds to outputs provided by the arrow keys.

15. The computer system of claim 14, wherein the outputs provided by the arrow keys are remapped to the trackball.

16. The computer system of claim 14, wherein the outputs provided by the arrow keys are redundant with respect to the second output of the trackball.

17. An input device for a computer comprising:
a housing configured as a mouse-type input device;
means for determining movement of the housing;
means for providing a first output corresponding to the movement of the housing; and
means for providing a second output corresponding to a two-dimensional motion input of a user.

18. The input device of claim 17, further comprising:
means, oriented for actuation by a thumb of a user, for providing left-click functionality.

19. The input device of claim 17, further comprising:
means, oriented for actuation by an index finger of a user, for providing right-click functionality.

20. The input device of claim 17, further comprising:
means, oriented for actuation by a middle finger of a user, for providing scroll functionality.
